(19) United States
(12) Patent Application Publication
(10) Pub. No.: US 2013/0223309 A1
(43) Pub. Date: Aug. 29, 2013

(54) MOBILE STATION AND POWER SAVING METHOD THEREOF

(71) Applicants: Yu-Fang Hsiao, Guishan Township (TW); Jenhui Chen, New Taipei City (TW); Woei-Hwa Tarn, New Taipei City (TW); Heng-Iang Hsu, Taipei City (TW)

(72) Inventors: Yu-Fang Hsiao, Guishan Township (TW); Jenhui Chen, New Taipei City (TW); Woei-Hwa Tarn, New Taipei City (TW); Heng-Iang Hsu, Taipei City (TW)

(21) Appl. No.: 13/461,484

(22) Filed: May 1, 2012

(30) Foreign Application Priority Data
Feb. 23, 2012 (TW) 101105985

(51) Int. Cl. H04W 52/02; H04W 72/04

(52) U.S. Cl. 370/311

(57) ABSTRACT

A mobile station and a power saving method thereof for a wireless communication system are provided. The wireless communication system comprises a base station and the mobile station. The mobile station stays in a sleep mode. The mobile station comprises a buffer, a transceiver, and a processor. The buffer is configured to temporarily store an uplink data packet. The transceiver is configured to receive a downlink traffic indication message during at least one listening interval. The processor, electrically connected to the transceiver and the buffer, is configured to determine that the downlink traffic indication message carries a non-having downlink data packet information to make the buffer continue to temporarily store the uplink data packet so that the mobile station continuously stays in the sleep mode.

### This application claims the benefit of priority based on Taiwan Patent Application No. 101105985 filed on Feb. 23, 2012, which is hereby incorporated by reference in its entirety.

### CROSS-REFERENCES TO RELATED APPLICATIONS

Not applicable.

### BACKGROUND OF THE INVENTION

1. Field of the Invention

The present invention relates to a mobile station and a power saving method thereof. More particularly, when the mobile station stays in a sleep mode, the present invention controls a time at which the mobile station transmits an uplink data packet so that an interval in which the uplink data packet is transmitted can overlap as much as possible with an interval in which a downlink data packet is received. The time duration in which the mobile station stays in the sleep mode can be extended for the purpose of power saving.

2. Descriptions of the Related Art

With the widespread use of wireless communications, extending the operating time of portable mobile stations (e.g., apparatuses with mobile communication functionality such as mobile phones, personal digital assistants (PDAs), notebook computers, and flat panel computers) has become an important problem in addition to the improvement of the communication quality.

For example, the IEEE 802.16e communication protocols have provided three power-saving modes in the prior art. The power-saving mode of type I primarily relates to non-real-time services. When a mobile station has stayed idle for a period of time, the mobile station enters the sleep mode which consists of alternating sleep intervals and listening intervals. The power saving method of type I is characterized in that, with the elapse of each listening interval, the duration of the subsequent sleep interval is doubled.

During each listening interval, the mobile station receives a downlink traffic indication message from a base station, which contains information regarding to whether the base station is to transmit a downlink data packet. If the downlink traffic indication message indicates that the base station has no downlink data packet to transmit and the mobile station has no uplink data packet to transmit to the base station either, then the mobile station keeps staying in the sleep mode. On the other hand, if the downlink traffic indication message indicates that the base station has a downlink data packet to transmit or the mobile station has an uplink data packet to transmit to the base station, then the mobile station leaves the sleep mode immediately. Accordingly, the mobile station must leave the sleep mode if either the mobile station or the base station has a data packet to transmit. This prevents the mobile station from staying in the sleep mode for an extended period of time, which makes it impossible to achieve the expected power-saving effect.

Accordingly, an urgent need exists in the art to provide a data transmission mechanism that can effectively extend the period of time in which the mobile station stays in the sleep mode to achieve the purpose of power saving.

### SUMMARY OF THE INVENTION

An objective of the present invention is to provide a mobile station and a power saving method thereof According to the present invention, the mobile station in a sleep mode keeps temporarily storing an uplink data packet according to the information carried in a downlink traffic indication message from a base station, and this can extend the period of time in which the mobile station stays in the sleep mode so as to achieve the purpose of power saving . In other words, the present invention controls a time at which the mobile station transmits the uplink data packet. In such a way, the interval of transmitting the uplink data packet and the interval of receiving the downlink data packet can overlap as much as possible so as to reduce the frequency of the mobile station leaving the sleep mode.

To achieve the aforesaid objective, the present invention discloses a mobile station for use in a wireless communication system. The wireless communication system comprises a base station and the mobile station. The mobile station stays in a sleep mode, and comprises a buffer, a transceiver and a processor. The buffer is configured to temporarily store an uplink data packet. The transceiver is configured to receive a downlink traffic indication message during at least one listening interval. The processor is electrically connected to the transceiver and the buffer, and configured to determine that the downlink traffic indication message carries non-having downlink data packet information to make the buffer continue to temporarily store the uplink data packet so that the mobile station continuously stays in the sleep mode.

To achieve the aforesaid objective, the present invention further discloses a power saving method for the aforesaid mobile station. The power saving method is executed by the processor of the mobile station, and comprises the following steps: enabling the buffer to temporarily store the uplink data packet; enabling the transceiver to receive the downlink traffic indication message during the at least one listening interval; and determining that the downlink traffic indication message carries the non-having downlink data packet information to make the buffer continue to temporarily store the uplink data packet so that the mobile station continuously stays in the sleep mode.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a wireless communication system 1 according to a first embodiment of the present invention;

FIG. 2 is a schematic view of a mobile station 13 according to the first embodiment of the present invention;

FIG. 3 is a schematic view depicting the operations of the mobile station according to a second embodiment of the present invention;

FIG. 4 is a schematic view depicting the operations of the mobile station according to a third embodiment of the present invention;

FIG. 5 is a flowchart diagram of a power saving method according to a fourth embodiment of the present invention; and

FIG. 6 is a flowchart diagram of a power saving method according to a fifth embodiment of the present invention.

### DESCRIPTION OF THE PREFERRED EMBODIMENT

The present invention provides a mobile station and a power saving method thereof. In the following descriptions, the present invention will be explained with reference to embodiments thereof It shall be appreciated that these embodiments are not intended to limit the present invention to any specific environment, applications or particular implementations described in these embodiments. Therefore, the description of these embodiments is only for the purpose of illustration rather than to limit the present invention, and the scope claimed in this application shall be governed by the claims. Additionally, in the following embodiments and the attached drawings, elements not directly related to the present invention are omitted from depiction; and dimensional relationships among individual elements in the attached drawings are illustrated only for ease of understanding but not to limit the actual scale.

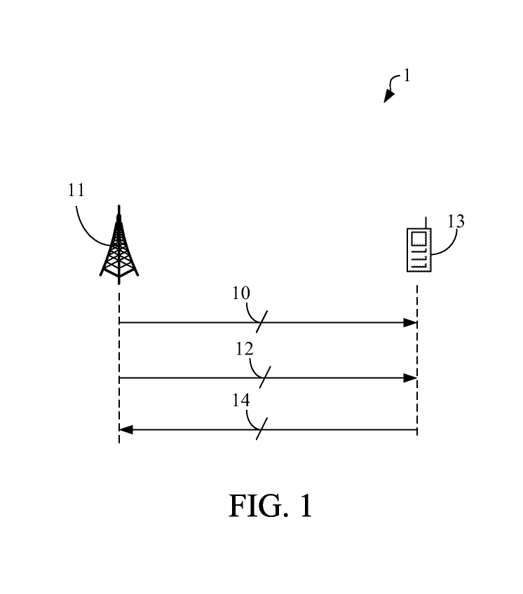

FIG. 1 is a schematic view of a wireless communication system 1 according to a first embodiment of the present invention. The wireless communication system 1 comprises a base station 11 and a mobile station 13. The technical contents of the present invention focus on operations between the mobile station 13 and the base station 11 when the mobile station 13 stays in the sleep mode. For simplicity of description, the following description will only focus on extending the time duration in which the mobile station 13 stays in the sleep mode so as to achieve the purpose of power saving; and other technical contents that are less related to the present invention will not be described.

When the mobile station 13 stays in the sleep mode, the base station 11 transmits a downlink traffic indication message 10 to the mobile station 13 during a listening interval of the sleep mode. The downlink traffic indication message 10 is used to inform the mobile station 13 whether the base station 11 is to transmit a downlink data packet 12 to the mobile station 13. After receiving the downlink traffic indication message 10, the mobile station 13 determines whether it is necessary to leave the sleep mode according to the information carried in the downlink traffic indication message 10.

According to the present invention, if there is an uplink data packet 14 to be transmitted to the base station 11 when the mobile station 13 stays in the sleep mode, then the mobile station 13 will temporarily store but not transmit the uplink data packet 14. Afterwards, if the information carried in the downlink traffic indication message 10 is a non-having downlink data packet information, the mobile station 13 keeps temporarily storing the uplink data packet 14 to keep staying in the sleep mode. Conversely, if the information carried in the downlink traffic indication message 10 is a having downlink data packet information, the mobile station 13 leaves the sleep mode to receive the downlink data packet 12 from the base station 11 and transmit the uplink data packet 14 to the base station 11. It shall be appreciated that for the simplicity of description, only an uplink data packet 14 is used for illustration herein; however, those of ordinary skill in the art can readily understand that multiple uplink data packets 14 may also be temporarily stored in the present invention until the mobile station 13 leaves the sleep mode and then the uplink data packets 14 are transmitted to the base station 11. Accordingly, any number of uplink data packets 14 that are temporarily stored shall all be within the scope of the present invention.

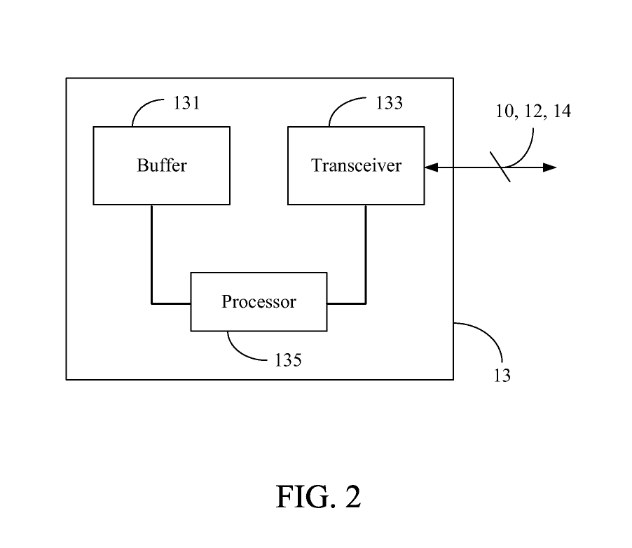

Furthermore, as shown in FIG. 2, the mobile station 13 comprises a buffer 131, a transceiver 133 and a processor 135. The buffer 131 is configured to temporarily store an uplink data packet 14. The transceiver 133 is configured to receive the downlink traffic indication message 10 and the downlink data packet 12 and transmit the uplink data packet 14. The processor 135 is electrically connected to the buffer 131 and the transceiver 133. The processor 135 is configured to determine that the downlink traffic indication message 10 carries a non-having downlink data packet information to make the buffer 131 continue to temporarily store the uplink data packet 14. Thus, the mobile station 13 can continuously stay in the sleep mode.

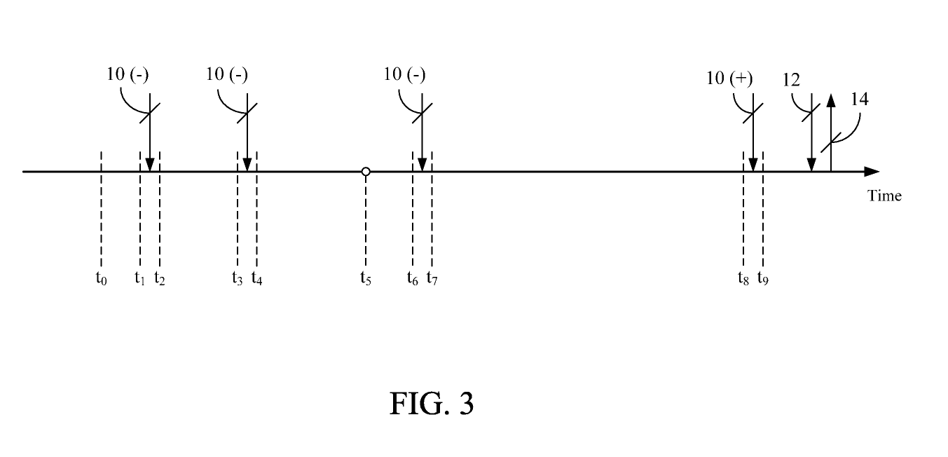

A second embodiment of the present invention is shown in FIG. 3, which depicts operations of the mobile station 13 in an aspect of the first embodiment. The mobile station 13 enters the sleep mode at a time point t₀. It shall be appreciated that the sleep mode of this embodiment conforms to the power-saving mode of type I in the IEEE 802.16e standard. However, in other embodiments, the sleep mode may also conform to provisions of other similar communication standards such as an IEEE 802.16m standard or the 3GPP Long Term Evolution (LTE) technology.

In FIG. 3, an interval from t₀ to t₁, an interval from t₂ to t₃, an interval from t₄ to t₆ and an interval from t₇ to t₈ are sleep intervals; and an interval from t₁ to t₂, an interval from t₃ to t₄, an interval from t₆ to t₇ and an interval from t₈ to t₉ are listening intervals. During each of the listening intervals, the transceiver 133 of the mobile station 13 receives the downlink traffic indication message 10 from the base station 11. After receiving the downlink traffic indication message 10, the processor 135 determines that the information carried in the downlink traffic indication message 10 is one of a non-having downlink packet information (MOB TRF-IND (−)) and a having downlink packet information (MOB TRF-IND (+)). It shall be appreciated that in FIG. 3, the 10 (−) represents the non-having downlink packet information carried in the downlink traffic indication message 10 and the 10 (+) represents the having downlink packet information carried by the downlink traffic indication message 10.

In this embodiment, during the interval from t₁ to t₂, the interval from t₃ to t₄ and the interval from t₆ to t₇, all the downlink traffic indication messages 10 received by the mobile station 13 carry the non-having downlink packet information. At a time point t₅, the processor 135 of the mobile station 13 generates the uplink data packet 14 and temporarily stores it in the buffer 131. Because the downlink traffic indication message 10 received during the interval from t₆ to t₇ still informs the mobile station 13 that the base station has no downlink data packet 12 to transmit yet, the processor 135 enables the buffer 131 to keep temporarily storing the uplink data packet 14 so that the mobile station 13 continuously stays in the sleep mode after the time point t₇.

During the interval from t₈ to t₉, the downlink traffic indication message 10 received by the mobile station 13 carries the having downlink packet information. Therefore, according to the having downlink packet information, the processor 135 enables the mobile station 13 to leave the sleep mode and enables the transceiver 133 to receive the downlink data packet 12 and transmit the uplink data packet 14 after the time point t₉. In other words, the mobile station 13 of the present invention has the uplink data packet 14 temporarily stored and will not leave the sleep mode until the information carried in the downlink traffic indication message 10 is the having downlink packet information, thereby, reducing the frequency at which the mobile station leaves the sleep mode. Therefore, as compared to the mobile station of the prior art which leaves the sleep mode immediately after the time point t₅, the time duration in which the mobile station 13 of the present invention can stay in the sleep mode can be extended to the time point (i.e., the time point t₉) at which the downlink traffic indication message 10 carrying the having downlink packet information is received within the listening interval.

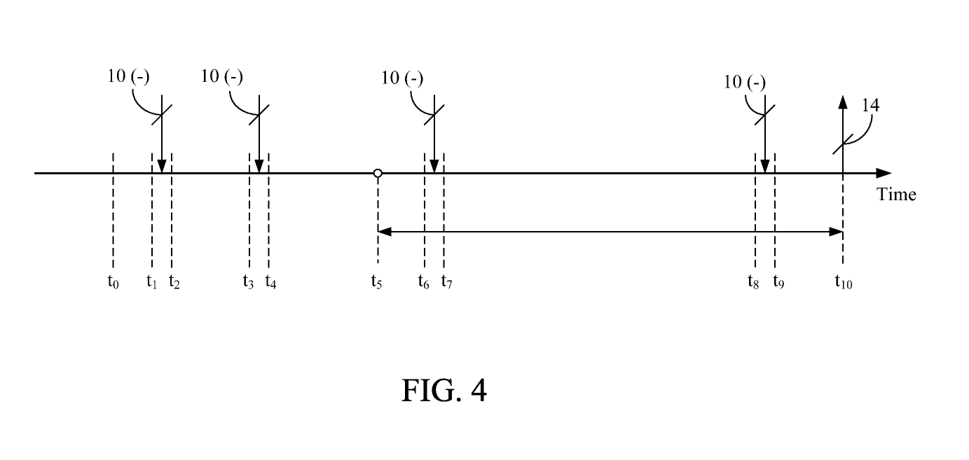

A third embodiment of the present invention is shown in FIG. 4, which depicts the operations of the mobile station 13 in another aspect of the first embodiment. This embodiment differs from the second embodiment in that, a threshold of a temporary storage time is defined and all the downlink traffic indication messages 10 received during the interval from t₁ to t₂, the interval from t₃ to t₄, the interval from t₆ to t₇ and the interval from t₈ to t₉ carry the non-having downlink packet information. For example, the threshold of the temporary storage time may be as indicated by the formula 1, but is not limited thereto.

T_{E}=Qₜ√λ_{μ}L (Formula 1)

where T_{E} represents the threshold, Qₜ represents an upper safety limit of the total packet size stored in the buffer, λ_{μ} represents an arrival rate of the uplink data packets, and L represents an average size of the uplink data packets.

At the time point t₅, the processor 135 of the mobile station 13 generates the uplink data packet 14 and temporarily stores it in the buffer 131. Then, the processor 135 enables the buffer 131 to keep temporarily storing the uplink data packet 14 until the temporary storage time reaches the threshold. As shown in FIG. 4, the threshold of the temporary storage time is equal to a time difference between t₅ and t₁₀ in this embodiment. After the processor 135 determines that the temporary storage time in which the buffer 131 temporarily stores the uplink data packet 14 reaches the threshold, the processor 135 enables the mobile station 13 to leave the sleep mode and enables the transceiver 133 to transmit the uplink data packet 14 to the base station 11.

In other words, by taking the total size of uplink data packets 14 that can be stored by the buffer 131 into consideration in this embodiment, unexpected problems can be prevented from occurring when the buffer 131 cannot temporarily store too many packets. On the other hand, the threshold of the temporary storage time may further be set according to the requirements of a user instead of being set according to the formula 1. For example, without considering the total size of uplink data packets 14 that can be stored by the buffer 131, the threshold may be set to be 10 minutes, 30 minutes or any time value that meets the requirement of non-real-time services.

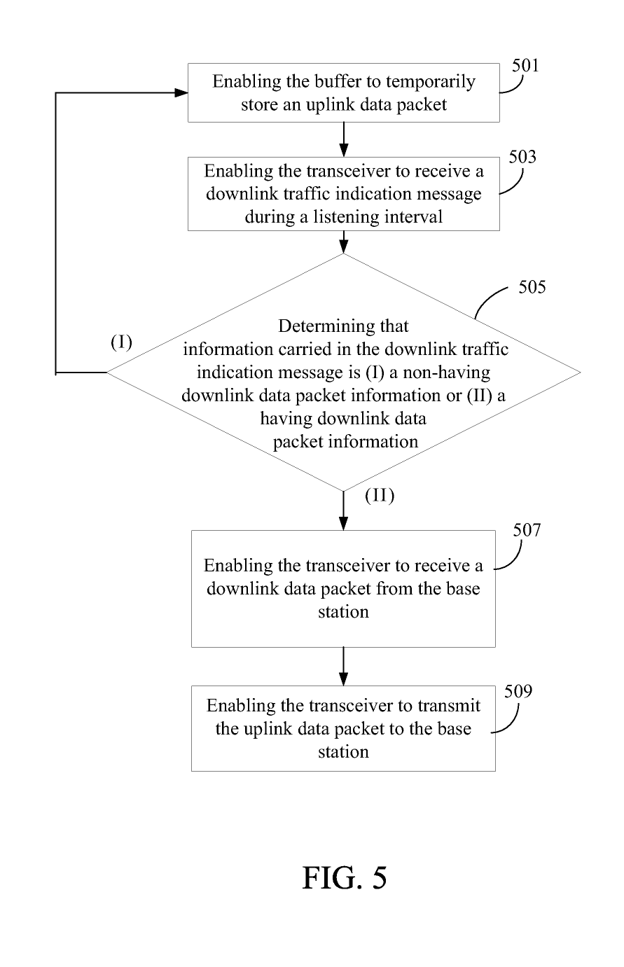

A fourth embodiment of the present invention is shown in FIG. 5, which is a flowchart diagram of a power saving method of the present invention. The power saving method is for use in a mobile station of a wireless communication system, e.g., the mobile station 13 of the wireless communication system 1 in the first embodiment or the second embodiment. The wireless communication system comprises a base station and a mobile station. The mobile station stays in a sleep status, and comprises a buffer, a processor and a transceiver. The power saving method is executed by the processor of the mobile station, as described below.

Firstly, step 501 is executed to enable the buffer to temporarily store an uplink data packet. Then, step 503 is executed to enable the transceiver to receive a downlink traffic indication message during a listening interval. Then, step 505 is executed to determine that information carried in the downlink traffic indication message is (I) a non-having downlink data packet information or (II) a having downlink data packet information. If the information carried in the downlink traffic indication message is (I) the non-having downlink data packet information, then step 501 is executed again to enable the buffer to keep temporarily storing the uplink data packet and step 503 is executed again to enable the transceiver to receive a downlink traffic indication message during the next listening interval. If the information carried in the downlink traffic indication message is (II) the having downlink data packet information, then step 507 is executed to enable the transceiver to receive a downlink data packet from the base station. Then, step 509 is executed to enable the transceiver to transmit the uplink data packet to the base station.

In addition to the aforesaid steps, the fourth embodiment can also execute all the operations and functions set forth in the first embodiment and the second embodiment. How the power saving method of the present invention executes these operations and functions can be readily appreciated by those of ordinary skill in the art based on the explanation of the first embodiment and the second embodiment, and thus will not be further described herein.

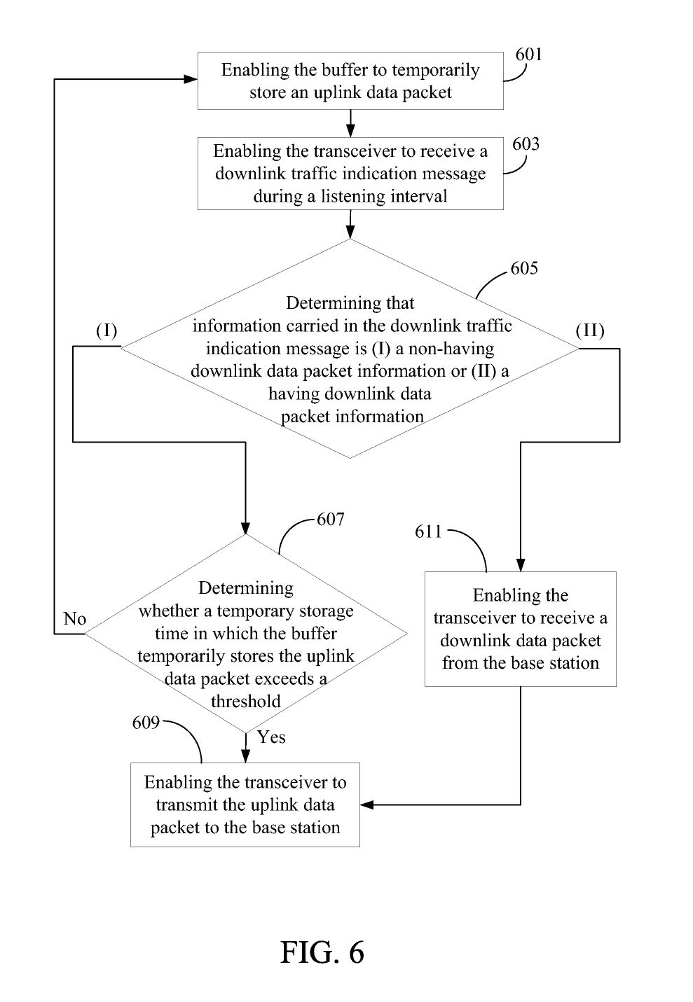

A fifth embodiment of the present invention is shown in FIG. 6, which is a flowchart diagram of a power saving method of the present invention. The power saving method is for use in a mobile station of a wireless communication system, e.g., the mobile station 13 of the wireless communication system 1 in the first embodiment or the third embodiment. The wireless communication system comprises a base station and a mobile station. The mobile station stays in a sleep status, and comprises a buffer, a processor and a transceiver. Unlike the fourth embodiment, the power saving method of this embodiment further takes the total size of the uplink data packets that can be stored by the buffer into consideration. The power saving method is executed by the processor of the mobile station, as described below.

First, step 601 is executed to enable the buffer to temporarily store an uplink data packet. Then, step 603 is executed to enable the transceiver to receive a downlink traffic indication message during a listening interval. Then, step 605 is executed to determine that information carried in the downlink traffic indication message is (I) a non-having downlink data packet information or (II) a having downlink data packet information. If the information carried in the downlink traffic indication message is (I) the non-having downlink data packet information, then step 607 is executed to determine whether a temporary storage time in which the buffer temporarily stores the uplink data packet exceeds a threshold. If the answer is “no”, then step 601 is executed again to enable the buffer to keep temporarily storing the uplink data packet and step 603 is executed again to enable the transceiver to receive a downlink traffic indication message during a next listening interval. If the answer is “yes”, then step 609 is executed to enable the transceiver to transmit the uplink data packet to the base station. If the information carried in the downlink traffic indication message is (II) the having downlink data packet information, then step 611 is executed to enable the transceiver to receive a downlink data packet from the base station. Then, step 609 is executed to enable the transceiver to transmit the uplink data packet to the base station.

In addition to the aforesaid steps, the fifth embodiment can also execute all the operations and functions set forth in the first embodiment and the third embodiment. How the power saving method of the present invention executes these operations and functions can be readily appreciated by those of ordinary skill in the art based on the explanation of the first embodiment and the third embodiment, and thus will not be further described herein.

According to the above descriptions, the mobile station and the power saving method thereof of the present invention enable the buffer to keep temporarily storing an uplink data packet according to the information carried in a downlink traffic indication message from a base station, and this can extend the period of time in which the mobile station stays in the sleep mode so as to achieve the purpose of power saving.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A mobile station for use in a wireless communication system, the wireless communication system comprising a base station and the mobile station, the mobile station staying in a sleep mode, the mobile station comprising:
a buffer, being configured to temporarily store an uplink data packet;
a transceiver, being configured to receive a downlink traffic indication message during at least one listening interval; and
a processor, being electrically connected to the transceiver and the buffer, and configured to determine that the downlink traffic indication message carries a non-having downlink data packet information to make the buffer continue to temporarily store the uplink data packet so that the mobile station continuously stays in the sleep mode.

2. The mobile station as claimed in claim 1, wherein the processor is further configured to determine that a temporary storage time of the buffer for temporarily storing the uplink data packet reaches a threshold so as to make the mobile station leave the sleep mode and to enable the transceiver to transmit the uplink data packet to the base station.

3. The mobile station as claimed in claim 1, wherein the transceiver is further configured to determine that the downlink traffic indication message carries a having downlink data packet information so as to make the mobile station leave the sleep mode and to enable the transceiver to receive a downlink data packet from the base station and to transmit the uplink data packet to the base station.

4. The mobile station as claimed in claim 1, wherein the wireless communication system conforms to an IEEE 802.16e standard.

5. A power saving method for a mobile station, the mobile station being for use in a wireless communication system, the wireless communication system comprising a base station and the mobile station, the mobile station comprising a buffer, a processor and a transceiver, the mobile station staying in a sleep mode, the power saving method being executed by the processor and comprising the following steps:
enabling the buffer to temporarily store an uplink data packet;
enabling the transceiver to receive a downlink traffic indication message during at least one listening interval; and
determining that the downlink traffic indication message carries a non-having downlink data packet information to make the buffer continue to temporarily store the uplink data packet so that the mobile station continuously stays in the sleep mode.

6. The power saving method as claimed in claim 5, further comprising the following steps:
determining that a temporary storage time of the buffer for temporarily storing the uplink data packet reaches a threshold so as to make the mobile station leave the sleep mode; and
enabling the transceiver to transmit the uplink data packet to the base station.

7. The power saving method as claimed in claim 5, further comprising the following steps:
determining that the downlink traffic indication message carries a having downlink data packet information so as to make the mobile station leave the sleep mode; and
enabling the transceiver to receive a downlink data packet from the base station and to transmit the uplink data packet to the base station.

8. The power saving method as claimed in claim 5, wherein the wireless communication system conforms to an IEEE 802.16e standard.
